(19) United States
(12) Patent Application Publication
(10) Pub. No.: US 2022/0260155 A1
(43) Pub. Date: Aug. 18, 2022

(54) Novel High-Pressure Sealing Ring with Custom-Shaped Profile

(71) Applicant: SPM Oil & Gas Inc., Fort Worth, TX (US)

(72) Inventor: Nadiya Fuller, Plano, TX (US)

(21) Appl. No.: 17/628,550

(22) PCT Filed: Jul. 15, 2020
(86) PCT No.: PCT/US2020/042191

§ 371 Date: Jan. 19, 2022

Related U.S. Application Data
(60) Provisional application No. 62/876,023, filed on Jul. 19, 2019.

(51) Int. Cl. F16J 15/10

(52) U.S. Cl. CPC F16J 15/106

(57) ABSTRACT

An annular seal includes a generally flat-sided toric seal body forming first and second annular convex sealing surfaces on its outer diameter surface and inner diameter surface, first and second annular wiper structures formed on both sides of the first and second convex sealing surfaces on the outer diameter and inner diameter surfaces, first and second rounded annular grooves disposed on both sides of the first and second convex sealing surfaces on the outer diameter and inner diameter surfaces, wherein the profiles of the inner and outer diameter surfaces of the seal are substantially symmetrical, and wherein the profiles of the first and second annular wiper structures and first and second rounded annular grooves disposed on both sides of the first and second convex sealing surfaces are substantially symmetrical.

### FIELD

The present disclosure relates to high-pressure seals, and in particular, the present disclosure is related to a to a sealing ring with a custom-shaped profile (W-ring) for high-pressure applications.

### BACKGROUND

Hydraulic fracturing is a process to obtain hydrocarbons such as natural gas and petroleum by injecting a fracking fluid or slurry at high pressure into a wellbore to create cracks in deep rock formations. The hydraulic fracturing process employs a variety of different types of equipment at the site of the well, including one or more positive displacement pumps, slurry blender, fracturing fluid tanks, high-pressure flow iron (pipe or conduit), valves, and pumps that are designed to move the highly abrasive and corrosive fracking slurry and other fluids at high pressures. Sealing elements used in these types of equipment must withstand the high pressure and corrosive nature of the fracking slurry and fluids.

### BRIEF DESCRIPTION OF THE DRAWINGS

FIGS. 1 and 2 are top perspective views of an exemplary embodiment of a sealing ring with a custom-shaped profile for high-pressure applications according to the teachings of the present disclosure;

FIG. 3 is a side view of an exemplary embodiment of a sealing ring with a custom-shaped profile for high-pressure applications according to the teachings of the present disclosure;

FIG. 4 is a top plan view of an exemplary embodiment of a sealing ring with a custom-shaped profile for high-pressure applications according to the teachings of the present disclosure;

FIG. 5 is a perspective cross-sectional view of a sealing ring with a custom-shaped profile for high-pressure applications according to the teachings of the present disclosure; and

FIGS. 6 and 7 are partial cross-sectional close-up views of an exemplary embodiment of a sealing ring with a custom-shaped profile for high-pressure applications according to the teachings of the present disclosure.

### DETAILED DESCRIPTION

Seals used in oil and gas fracturing and production applications have to operate in harsh environments, including being subjected to high pressures, pulsating dynamic loads, and corrosive (e.g., up to 18% HCl) and highly abrasive liquids. O-rings, D-rings, and Polypack seals (sloped lip creates seal and wiping at one feature) are often used in static applications, i.e., between two parts that do not move relative to one another. Due to a number of reasons, these conventional seals are often short-lived and required frequent maintenance and replacement. For example, because O-rings tend to roll during installation, the result is a distortion of the sealing profile and general displacement of the seal from its seat. The sealing surface of O-rings is also exposed to the high-pressure harsh and abrasive slurry. Although the flat inner diameter surface of the D-ring seal helps to keep it from rolling during installation, it is still subject to shortened lifespan due to erosion of its sealing surface to the frack slurry. A conventional Polypack seal tends to have the opposite problem—it offers some protection of its sealing surface from slurry but is still subject to deformity, distortion, and displacement due to rolling during installation, especially for seals with larger diameters.

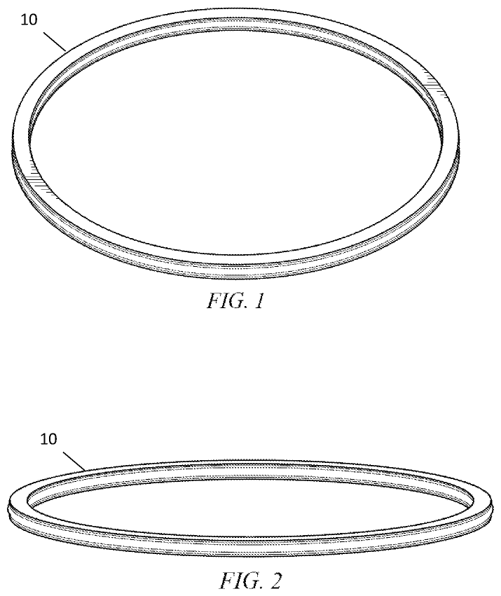

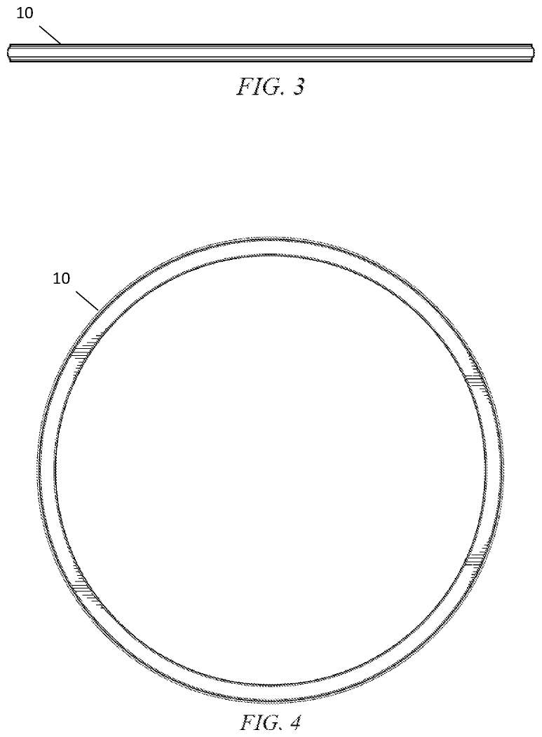

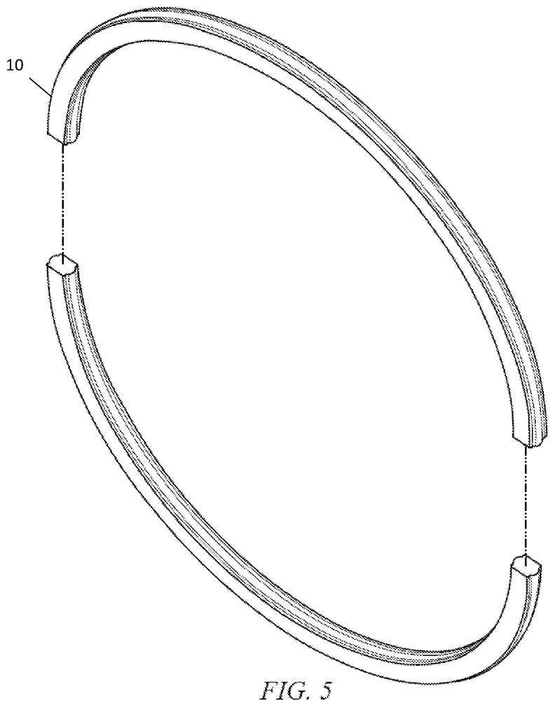

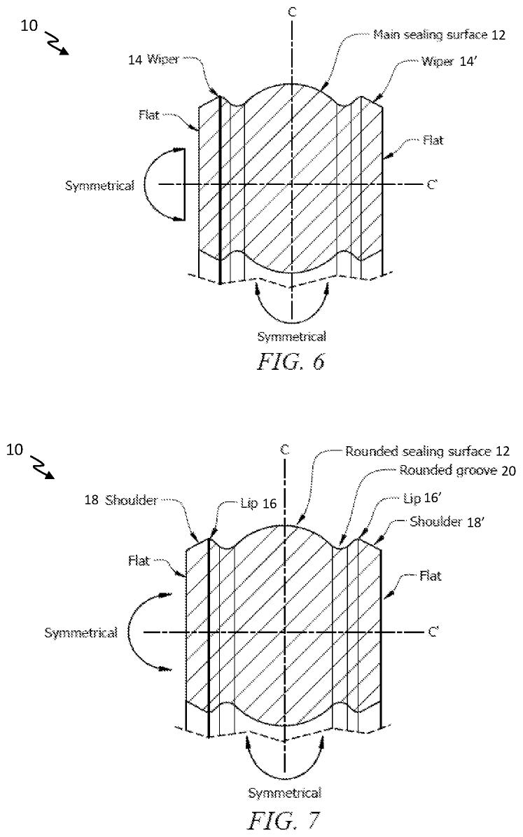

FIGS. 1-5 are various views of an exemplary embodiment of a sealing ring 10 with a custom-shaped profile (named W-ring) for high-pressure applications according to the teachings of the present disclosure, and FIGS. 6 and 7 are partial cross-sectional close-up views of an exemplary embodiment of a sealing ring 10 with a custom-shaped profile for high-pressure applications according to the teachings of the present disclosure. Referring specifically to the cross-sectional view of the annular seal in FIGS. 6 and 7, the generally toric seal or gasket has an outer diameter surface profile that is similar to a W, with a center convex main sealing surface 12 flanked on both sides by wiper structures 14 and 14′. The center convex main sealing surface 12 preferably has a rounded profile, and the wiper structures 14 and 14′ on either side have a protruding lip 16 and 16′ with a sloping shoulder 18 and 18′. The channel or groove 20 and 20′ between the rounded main sealing surface 12 and the lip 16 and 16′ is also preferably rounded, as shown. The cross-section of the seal is symmetrical along the center axis C, and also along its orthogonal axis C′. In other words, the inside diameter surface profile is a mirror image of the outer diameter profile (along line C′), and the wiper structure on either side of the rounded sealing surface is also mirror images of one another along line C. For the sake of clarity, the inner diameter features are not labeled in FIGS. 6 and 7.

The wiper structures 14 and 14′ that flank the sides of the main sealing surface 12 serve two functions—1) stabilize the seal body and prevents deformation, distortion, and displacement during installation; and 2) block and protect the main sealing surface 12 from the corrosive fracturing slurry. Further, because the seal structure is symmetrical along line C, errors arising from incorrect orientation during installation are also easily avoided. By re-engineering the profile on both the outer and inner diameter surfaces of the seal, both benefit from the advantages arising from the new custom-shaped profile.

The seal may be constructed by extrusion, injection molding, pressure molding, or transfer molding using elastomers and other suitable materials that can retain its shape and be able to withstand highly corrosive and abrasive fluids. The present seal is designed to be a high-pressure seal along both its outer diameter surface and inner diameter surface to be utilized in static, semi-static, and dynamic oil and gas fracturing applications.

The features of the present invention which are believed to be novel are set forth below with particularity in the appended claims. However, modifications, variations, and changes to the exemplary embodiments described above will be apparent to those skilled in the art, and the custom-shaped profile seal ring described herein thus encompasses such modifications, variations, and changes and are not limited to the specific embodiments described herein.

1. An annular seal for high-pressure applications, comprising:
a generally flat-sided toric seal body forming first and second convex sealing surfaces on its outer diameter surface and inner diameter surface; and
first and second protruding wiper structures formed on both sides of the first and second convex sealing surfaces on the outer diameter and inner diameter surfaces.

2. The annular seal of claim 1, further comprising first and second rounded grooves separate the first and second wiper structures from the first convex sealing surface on the outer diameter surface.

3. The annular seal of claim 1, further comprising first and second rounded grooves separate the first and wiper structures from the first convex sealing surface on the inner diameter surface.

4. The annular seal of claim 1, further comprising first and second slanted shoulders flanking the first and wiper structures on the inner and outer diameter surfaces.

5. The annual seal of claim 1, wherein a cross-section of the annular seal is symmetrical along both center axes of the cross-section.

6. An annular seal comprising:
a generally flat-sided toric seal body forming first and second annular convex sealing surfaces on its outer diameter surface and inner diameter surface;
first and second annular wiper structures formed on both sides of the first and second convex sealing surfaces on the outer diameter and inner diameter surfaces;
first and second rounded annular grooves disposed on both sides of the first and second convex sealing surfaces on the outer diameter and inner diameter surfaces;
wherein the profiles of the inner and outer diameter surfaces of the seal are substantially symmetrical; and
wherein the profiles of the first and second annular wiper structures and first and second rounded annular grooves disposed on both sides of the first and second convex sealing surfaces are substantially symmetrical.

7. The annular seal of claim 6, further comprising first and second slanted shoulders flanking the first and wiper structures on the inner and outer diameter surfaces.

8. An annular seal for applications involving high-pressure corrosive and abrasive fluids, comprising:
a generally toric seal body forming first and second convex sealing surfaces on its outer diameter surface and inner diameter surface;
first and second annular lip structures formed on both sides of the first and second convex sealing surfaces on the outer diameter and inner diameter surfaces, wherein the annular lip structures add stability to the seal body and block the corrosive and abrasive fluids from reaching the convex sealing surfaces;
first and second rounded annular grooves disposed on both sides of the first and second convex sealing surfaces on the outer diameter and inner diameter surfaces;
wherein the cross-sectional profiles of the inner and outer diameter surfaces of the seal are substantially symmetrical; and
wherein the cross-sectional profiles of the first and second annular lip structures and first and second rounded annular grooves disposed on both sides of the first and second convex sealing surfaces are substantially symmetrical.

9. The annular seal of claim 8, further comprising first and second slanted shoulders flanking the first and wiper structures on the inner and outer diameter surfaces.

10. The annular seal of claim 8, where the generally toric seal body has two planar sides.
